(19) United States
(12) Patent Application Publication
(10) Pub. No.: US 2020/0340709 A1
(43) Pub. Date: Oct. 29, 2020

(54) FLUID HEATING DEVICE

(71) Applicant: Byungho KANG, Daegu (KR)

(72) Inventor: Byungho KANG, Daegu (KR)

(21) Appl. No.: 16/956,367

(22) PCT Filed: Oct. 1, 2018
(86) PCT No.: PCT/KR2018/011622

§ 371 Date: Jun. 19, 2020

(30) Foreign Application Priority Data
Dec. 21, 2017 (KR) 10-2017-0176957

(51) Int. Cl. F24H 1/20; F24H 9/18; H05B 3/18

(52) U.S. Cl. CPC F24H 1/202; H05B 3/18; F24H 9/18

(57) ABSTRACT

The present invention relates to a fluid heating apparatus, comprising: a housing having an upper outlet formed on the upper surface thereof, a lower outlet formed on the lower surface thereof, and at least one inlet formed on one side thereof; and a heating unit installed inside the housing and generating heat by receiving power from the outside. According to the present invention as described above, since a time for heating a fluid is remarkably shortened, the fluid can be heated more quickly to a desired temperature, and thus, power consumption can be significantly reduced.

### TECHNICAL FIELD

The present invention relates to a fluid heating device, and more specifically, to a fluid heating device which can induce a circulating flow of a fluid in a vertical direction not only to uniformly heat the fluid, but also to significantly shorten the heating time of the fluid by the generated circulating flow.

### BACKGROUND ART

In general, a fluid heating device is classified into a type of heating a fluid with heat generated by burning fuel and a type of heating a fluid with heat generated by electric energy.

In recent years, as the environmental problem has emerged seriously, the type of heating the fluid with heat generated by burning fuel is rarely used because a large amount of pollutants are discharged during the combustion process of fuel.

A fluid heating device using electric energy, which can be used wherever electricity is supplied and does not emit pollutants because there is no process of burning fuel, has been recommended.

Meanwhile, as shown in FIG. 1, a conventional fluid heating device using electrical energy includes a storage tank 100 for storing a fluid, and a heating unit 200 installed to be in contact with the fluid on an inner side of the storage tank 100.

In the conventional fluid heating device described above, the heating unit 200 generates heat by electric energy supplied from an outside, and the heating unit 200 heats the fluid in the storage tank 100 by heating the adjacent fluid.

However, according to the conventional fluid heating device, it takes relatively long time to uniformly heat the fluid in the storage tank 100 because only the fluid located in the area adjacent to the heating unit 200, that is, the fluid in the vicinity of the heating unit 200 is heated.

Accordingly, as the power consumption is excessive, the cost increases significantly.

In addition, since the heating unit 200 is required to be separately installed at one side of the storage tank 100, the installation work is cumbersome.

### DISCLOSURE

### Technical Problem

The present invention has been proposed to solve the above problems. An object of the present invention is to provide a fluid heating device that induces a circulating flow of a fluid in a vertical direction not only to uniformly heat the fluid but also to significantly shorten the heating time of the fluid by the generated circulating flow.

### Technical Solution

According to an aspect of the present invention, there is provided a fluid heating device which includes a housing having an upper outlet formed on an upper surface thereof, a lower outlet formed on a lower surface thereof, and at least one inlet formed on one side thereof; and at least one heating unit installed in the housing and receiving power from the an outside to generate heat.

Preferably, the fluid heating device further includes at least one fixing unit for fixing the heating unit in the housing, wherein the heating unit is installed to be spaced outward by a predetermined interval from the housing by the fixing unit.

Preferably, the fluid heating device further includes a fixing body coupled to one inner side of the housing; and at least one supporting bar extending outward from one side of the fixing body, and having a plurality of supporting grooves formed along outer portions of the supporting bar and spaced apart from each other by a predetermined interval.

Preferably, the heating unit includes a heating wire having a predetermined length to generate heat by receiving power from an outside; copper wires disposed at upper and lower portions of the heating wire in parallel to each other to generate heat by receiving power from the outside; and a cladding material for covering the heating wire and the copper wires, wherein the cladding material is formed of a heat-resistant silicone material.

### Advantageous Effects

According to the present invention described above, by inducing the circulating flow of the fluid in the vertical direction to uniformly heat the fluid, it is possible to supply the fluid having a uniform temperature.

In addition, the heating time of the fluid is significantly shortened by the generated circulating flow, so that the power supply time is greatly reduced, thereby greatly reducing the power consumption.

### DESCRIPTION OF DRAWINGS

FIG. 1 is a schematic view of a fluid heating device according to the related art.

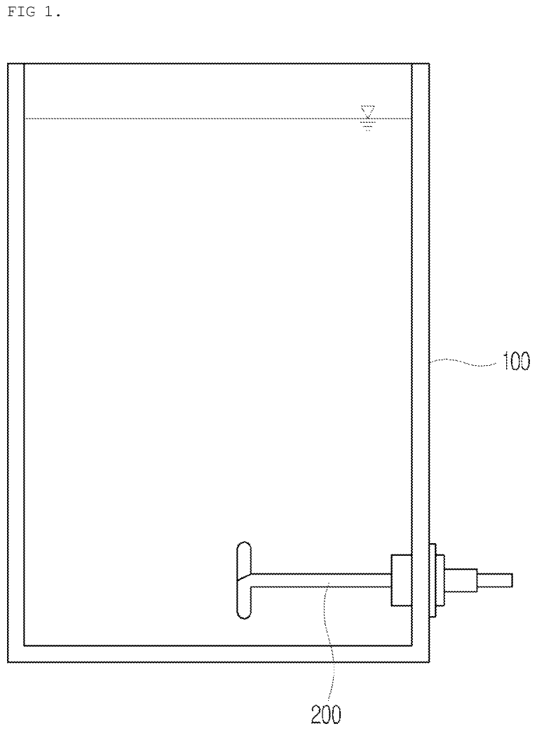

FIG. 2 is a perspective view of a fluid heating device according to an embodiment of the present invention.

FIG. 3 is an exploded perspective view of a fluid heating device according to an embodiment of the present invention.

FIG. 4 is a cross-sectional perspective view of a heating unit according to an embodiment of the present invention.

FIG. 5 is a view illustrating an operation of a fluid heating device according to an embodiment of the present invention.

FIG. 6 is a perspective view of a fluid heating device according to another embodiment of the present invention.

FIG. 7 is an exploded perspective view of a fluid heating device according to another embodiment of the present invention.

### BEST MODE

### Mode for Invention

Hereinafter, exemplary embodiments of the present disclosure will be described in detail with reference to the accompanying drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure rather unclear.

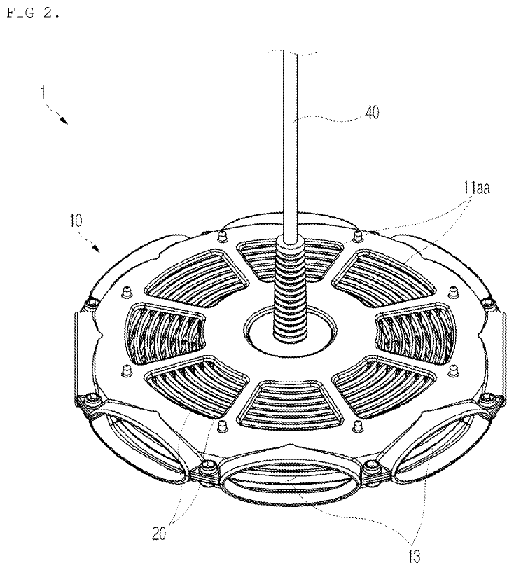

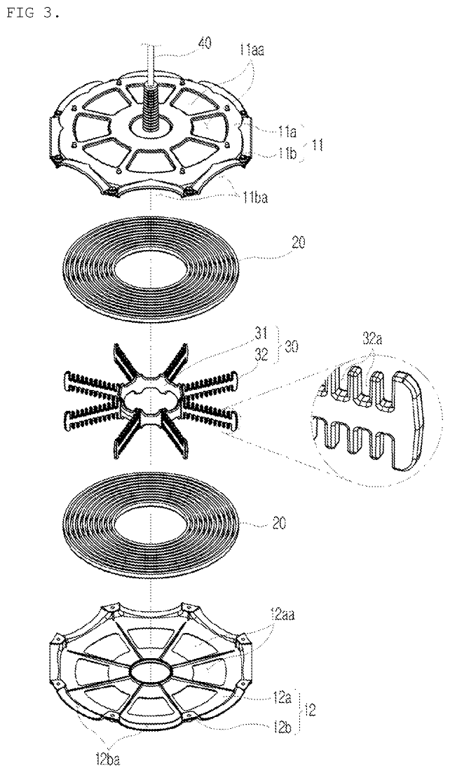

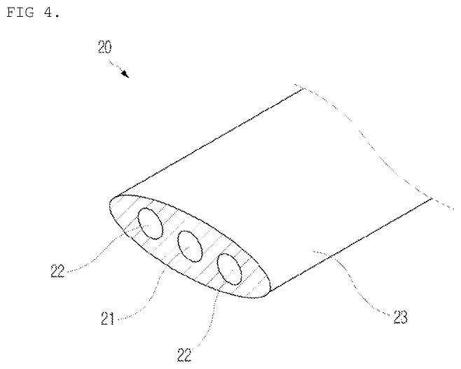

FIG. 2 is a perspective view of a fluid heating device according to an embodiment of the present invention. FIG. 3 is an exploded perspective view of a fluid heating device according to an embodiment of the present invention. FIG. 4 is a cross-sectional perspective view of a heating unit according to an embodiment of the present invention.

Referring to FIGS. 2 to 4, a fluid heating device 1 according to an embodiment of the present invention includes a housing 10, a heating unit 20, a fixing means 30 and a power supplying unit 40.

The housing 10, which provides a smooth circulation structure of the fluid heated by the heating unit 20, which will be described later, includes an upper housing 11 and a lower housing 12.

The upper housing 11 includes a disk-shaped upper plate 11a formed outward and curved downward, and a first side plate 11b formed outward and bent downward from an edge of the upper plate 11a. The upper plate 11a includes a plurality of trapezoidal upper outlets 11aa installed in a circumferential direction, such that the upper outlets 11aa provides a path through which the fluid, which flows into the housing 10 and heated by the heating unit 20, flows out upward of the housing 10.

The first side plate 11b includes a plurality of first incision grooves 11ba formed to be rounded upward from one side of a lower end thereof in the circumferential direction.

When the upper and lower housings 11 and 12 are coupled to each other, the first incision grooves 11b form an inlet 13 providing an inflow path of a fluid on a side surface of the housing 10 together with a second incision groove 12ba of a second side plate 12b, which will be described later.

The lower housing 12 includes a disc-shaped lower plate 12a formed outward and curved upward, and a second side plate 12b formed outward and bent upward from the edge of the lower plate 12a.

The lower plate 12a includes a plurality of trapezoidal lower outlets 12aa installed in a circumferential direction, such that the lower outlets 12aa provides a path through which the fluid, which flows into the housing 10 and heated by the heating unit 20, flows out downward of the housing 10.

The second side plate 12b includes a plurality of second incision grooves 12ba formed to be rounded downward from one side of an upper end thereof in the circumferential direction

When the upper and lower housings 11 and 12 are coupled to each other, the second incision grooves 12b form the inlet 13 providing the inflow path of a fluid on the side surface of the housing 10 together with the first incision groove 11ba of the first side plate 11b, which will be described later.

The heating unit 20 includes the pair of heating units 20 which are spaced apart from each other in a vertical direction in the housing 10. The heating units 20 receive power from an outside to heat the fluid flowing into the housing 10 and each includes a heating wire 21, copper wires 22 and a cladding material 23.

The heating wire 21 has a predetermined length, and is supplied with power from an outside to generate heat, thereby supplying a heat source for heating the fluid.

The copper wires 22 are arranged side by side on the upper/lower portions of the heating wire 21, and are supplied with power from an outside to generate heat, thereby supplying the heat source for heating the fluid.

The cladding 23 covers the outer surfaces of the heating wire 21 and the copper wires 22 to prevent the current flowing through the heating wire 21 and the copper wires 22 from leaking into the fluid, and prevent the heating wire 21 and the copper wires 22 from being oxidized. Preferably, the cladding material 23 is made of a heat-resistant silicone material.

As described above, the heating wire 21 and the copper wires 22 are arranged in parallel with each other, so that the heating unit 20 of the present invention may improve the heating efficiency by increasing the contact surface area with the fluid.

In addition, since the heat-resistant silicone material is used as the cladding material 23, surface damage due to heat does not occur even when it is used for a long time, so that it is possible to prevent foreign matters from adhering to the surface of the cladding material.

The fixing unit 30 fixes the heating unit 20 to an inside of the housing 10. The pair of heating units 20 are arranged outward of the housing 10 to be spaced apart from each other by a predetermined interval, and the pair of heating units 20 are arranged to be spaced apart from each other in the vertical direction inside the housing 10. The heating unit 20 includes a fixing body 31 and a supporting bar 32.

The fixing body 31 is formed in a substantially hollow cylindrical shape, and has upper/lower ends which are respectively coupled to the central sides of the inner surfaces of the upper housing 11 and the lower housing 12.

The supporting bar 32 is formed to extend outwardly from one side surface of the fixing body 32, and includes a plurality of supporting bars 32 which are formed to be spaced apart from each other by a predetermined interval along the side of the fixing body 31.

In addition, the supporting bar 32 is formed outward on upper and lower sides with a plurality of supporting grooves 32a spaced apart from each other by a predetermined interval.

The supporting grooves 32a serve to arrange the pair of heating units 20 disposed outward of the housing 10 on the upper and lower sides based on the fixing unit 30 to be spaced apart from each other by the predetermined interval.

As described above, according to the present invention, as the heating units 20 are arranged outward of the housing to be spaced apart from each other by the predetermined interval by the fixing unit 30, it is possible to sufficiently secure the surface area with the fluid flowing into the housing 10.

The power supplying unit 40 has one end which is coupled to the center of the upper surface of the upper housing 11 and electrically connected to the heating unit installed inside the housing 10, and an opposite end which is formed in the form of a cable extending in the upper direction and serves to supply external power to the heating unit 20.

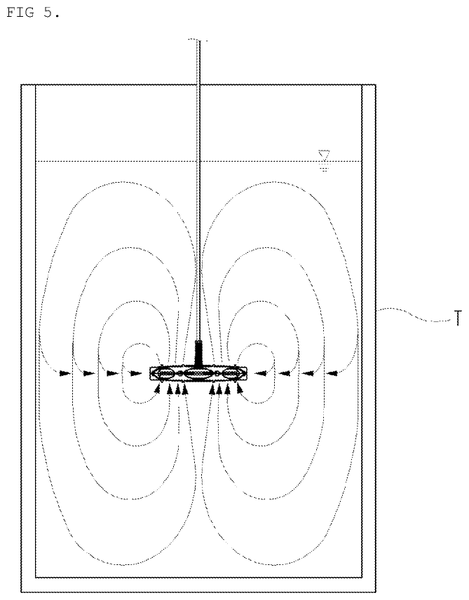

FIG. 5 is a view illustrating an operation of a fluid heating device according to an embodiment of the present invention.

Referring to FIG. 5, the fluid heating device 1 according to an embodiment of the present invention is installed at a position spaced apart from a bottom surface of the storage tank T in the storage tank T in which the fluid is stored therein.

Looking at the operation of the present invention, the fluid heated by the heating unit 20 in the housing 10 is discharged to the upper portion of the housing 10 through the upper outlet 11aa.

Accordingly, the fluid located in the upper portion of the housing 10 is moved downward by the heated fluid discharged to the upper portion of the housing 10 through the upper outlet 11aa.

In this case, some of the fluid moving from the upper portion to the lower portion of the housing 10 is re-entered into the inlet 13 formed on the side of the housing 10 and then, reheated by the heating unit 20 inside the housing 10, thereby forming a flow discharged to the upper portion of the housing 10 through the upper outlet 11aa.

Then, the remaining part of the fluid moving from the upper portion of the housing 10 to the lower portion is moved to the lower portion of the housing 10. Accordingly, the fluid located at the lower portion of the housing 10 flows into the outlet 12aa while beings moved to the upper portion of the lower portion of the housing 10, and the fluid flowing into the lower outlet 12aa is reheated by the heating unit 20 in the housing 10. Then, a flow discharged to the upper part of the housing 10 through the upper outlet 11aa is formed.

As described above, according to the present invention, the circulating flow, which connects the upper outlet 11aa and the inlet 13 of the housing and the upper outlet 11a and the lower outlet 12aa of the housing, may be continuously generated by the fluid discharged to the upper portion of the housing 10 through the upper outlet 11a of the housing 10, such that it is possible to not only uniformly heat the fluid contained in the storage tank T, but also significantly shorten the heating time of the fluid by the generated circulating flow.

According to the present invention described above, due to the structure in which the power supplying unit 40 in the form of a cable for supplying power to the heating unit 20 is coupled to one side of the housing, any additional installation works are for installing the heating unit to one side of the storage tank according to the related art installation not required, and the fluid heating device can be used by being inserted into the fluid contained in the storage tank T, so that it is possible to provide convenience to the user.

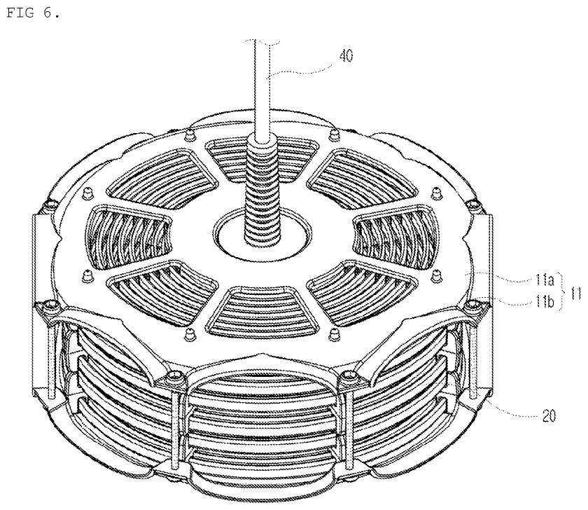

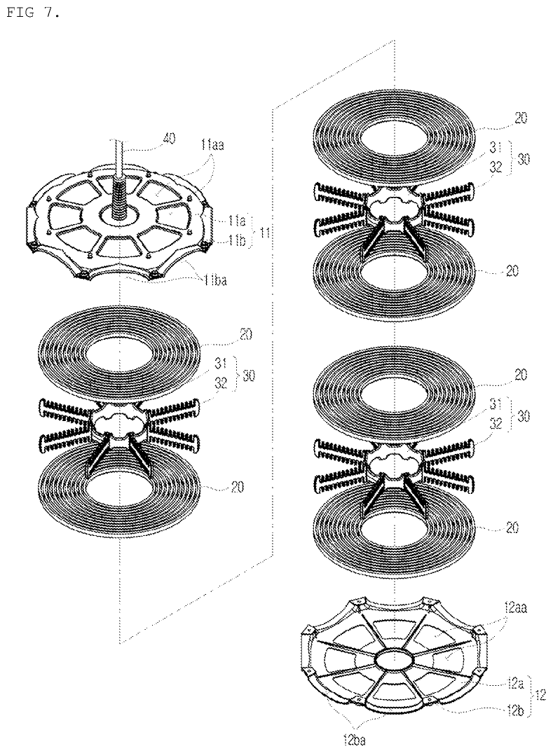

FIG. 6 is a perspective view of a fluid heating device according to another embodiment of the present invention. FIG. 7 is an exploded perspective view of a fluid heating device according to another embodiment of the present invention.

Since the fluid heating device 1 according to another embodiment of the present invention has the same detailed configuration as the present invention, the detailed description thereof will be omitted.

Referring to FIGS. 6 and 7, the fluid heating device 1 according to another embodiment of the present invention is formed in a structure in which the plurality of fixing units 30 are stacked mutually in the vertical direction, and the pair of heating units 20 disposed on the upper/lower portions of the fixing unit 30 are installed on the corresponding upper/lower portions of the fixing unit 30, respectively.

Accordingly, the present invention may heat the fluid to a desired temperature within a shorter time.

Although the present invention has been described with reference to preferable embodiments, various modifications, additions and substitutions are possible without departing the gist and the scope of the present invention. Accordingly, the appended claims will cover such modifications or variations that fall within the gist of the present invention.

1. A fluid heating device comprising:
a housing having an upper outlet formed on an upper surface thereof, a lower outlet formed on a lower surface thereof, and at least one inlet formed on one side thereof; and at least one heating unit installed in the housing and receiving power from an outside to generate heat.

2. The fluid heating device of claim 1, further comprising at least one fixing unit for fixing the heating unit in the housing, wherein the heating unit is installed to be spaced outward by a predetermined interval from the housing by the fixing unit.

3. The fluid heating device of claim 2, further comprising:
a fixing body coupled to one inner side of the housing; and at least one supporting bar extending outward from one side of the fixing body, and having a plurality of supporting grooves formed along outer portions of the supporting bar and spaced apart from each other by a predetermined interval.

4. The fluid heating device of claim 1, wherein the heating unit includes:
a heating wire having a predetermined length to generate heat by receiving power from an outside;
copper wires disposed at upper and lower portions of the heating wire in parallel to each other to generate heat by receiving power from the outside; and a cladding material for covering the heating wire and the copper wires, and wherein the cladding material is formed of a heat-resistant silicone material.
